(19) United States
(12) Patent Application Publication
(10) Pub. No.: US 2017/0298483 A1
(43) Pub. Date: Oct. 19, 2017

(54) MOTOR VEHICLE, CHASSIS COMPONENT, IN PARTICULAR FOR A CHASSIS COMPONENT AND USE OF THE CASSIS COMPONENT AND OF A MATERIAL

(71) Applicant: Benteler Steel/Tube GmbH, Paderborn (DE)

(72) Inventors: Marco Walterfang, Paderborn (DE); Jozef Balun, Schlangen (DE); Thomas Fortmeier, Delbrück (DE); Leonhard Rose, Borchen (DE)

(21) Appl. No.: 15/487,816

(22) Filed: Apr. 14, 2017

(30) Foreign Application Priority Data
Apr. 18, 2016 (DE) 10 2016 107 143.9

(51) Int. Cl. C22C 38/26; C22C 38/00; C22C 38/02; B60G 7/00; C22C 38/06; C22C 38/04

(52) U.S. Cl. CPC C22C 38/26; C22C 38/06; C22C 38/04; C22C 38/02; B60G 7/001; C22C 38/001; B60Y 2304/03; B60Y 2410/12

(57) ABSTRACT

The present invention relates to a motor vehicle with at least one chassis component (1). The chassis component is characterized in that the chassis component (1) has a yield strength Rp0.2 of at least 600 MPa, a tensile strength Rm of at least 850 MPa and is utilized in a delivery condition air-hardened and in that the chassis component (1) consists of an air-hardening, mainly bainitic material. Furthermore a chassis component and a material for a chassis component are described.

### REFERENCE TO PENDING PRIOR PATENT APPLICATION

This patent application claims benefit of German Patent Application No. 10 2016 107 143.9, filed 18 Apr. 2016 by Benteler Steel/Tube GmbH for MOTOR VEHICLE, CHASSIS COMPONENT, IN PARTICULAR FOR A CHASSIS COMPONENT AND USE OF THE CHASSIS COMPONENT AND OF A MATERIAL, which patent application is hereby incorporated herein by reference.

### FIELD OF THE INVENTION

Nowadays in the motor vehicle industry the demands with respect to the weight of motor vehicles are increased. It is necessary to keep the weight as low as possible in order to keep the fuel consumption low. Nevertheless, the costs should be kept low and in addition the motor vehicles have to comply with safety requirements.

### BACKGROUND OF THE INVENTION

The invention is based on the finding, that this problem can be solved, by manufacturing at least one chassis component of the chassis of a motor vehicle with suitable properties.

### SUMMARY OF THE INVENTION

According to a first aspect, the problem is thus solved by a motor vehicle with at least one chassis component. The motor vehicle is characterized in that the chassis component has a yield strength Rp0.2 of at least 600 MPa, a tensile strength Rm of at least 850 MPa and in that it is applied in delivery condition air-hardened and in that the chassis component consists of an air-hardening, mainly bainitic material. Preferably, the tensile strength is at least 900 MPa.

Preferably, the motor vehicle is a commercial vehicle. According to the invention components, which are part of the wheel suspension and/or part of the steering system, are referred to as chassis components.

Preferably, the invention relates to a commercial vehicle with at least one tie rod, steering rod, coupling rod, axle guide or a tubular part with tension-compression load, which each have a yield strength Rp0.2>=600 MPa and a tensile strength of Rm>=850 MPa, which are present in the condition air-hardened and consist of an air-hardening, mainly bainitic material.

According to a further aspect, the invention relates to a chassis component, which is characterized in that the chassis component has a yield strength Rp0.2 of at least 600 MPa, a tensile strength Rm of at least 850 MPa and is utilized in a delivery condition air-hardened and that the chassis component consists of an air-hardening, mainly bainitic material.

By utilizing in the motor vehicle according to the invention a chassis component, which consists of an air-hardening, mainly bainitic material, which has a yield strength of above 600 MPa and a tensile strength of above 850 MPa and which is used in a delivery condition air-hardened, the chassis component can be used without breaching the security requirements and can still have lower wall thickness or material thickness. Thereby, the weight of the chassis component and thus of the motor vehicle can be reduced and the security requirements nevertheless can be complied with. In addition, in particular due to the use of a chassis component in the delivery condition air-hardened, the chassis component can be surface treated in a simple manner, in particular lacquered or provided with a different coating. Thereby, the chassis component can be protected and thus the safety of the chassis component can be further increased. In particular, a high force can be absorbed by the chassis component, without having to fear damaging of the chassis component.

According to a preferred embodiment, the chassis component is part of a wheel suspension and/or steering system of the motor vehicle. In particular, the chassis component preferably is a tie rod.

In particular, a connecting rod, which is used with a rigid axle of a vehicle, is referred to as tie rod. The tie rod is therein preferably used via tie rod joints and steering arms at the axle sides of a motor vehicle axle. Tension and/or compression loads act in particular on tie rods during the use of the motor vehicle. In addition, bending loads may act on the tie rod. With the yield strength and tensile strength according to the invention, as well as due to the condition air-hardened, the chassis component can sustain these challenges.

Further embodiments of the chassis component are, in particular, a steering rod, a coupling rod, an axle guide or a different tubular part with tension-compression load. These components are as well subject to considerable loads when utilized in a motor vehicle.

Wheels of a motor vehicle are usually supported on steering stubs. The steering stubs may be attached rigidly to a rigid axle of the motor vehicle. In case of single-wheel suspension the steering stubs may also be connected for example to the vehicle body via so called axle guides. In case of axles, which are steered, the connection to the vehicle body is generally made via a tie rod.

According to the invention, the chassis component consists of an air-hardening, mainly bainitic material. Thereby, on the one hand the characteristic values, which are demanded by the present invention, can be fulfilled in a simple manner by the structure of the material which is mainly bainitic. On the other hand, due to the bainitic structure, the durability of the chassis component can be increased even under dynamic load.

According to a preferred embodiment, the structure, i.e. the microstructure, of the chassis element contains at least 60% bainite, remainder ferrite and/or martensite and/or retained austenite. In particular, the remainder consists of at least 15% ferrite and maximum 10% martensite and/or retained austenite.

In known bainitic materials, which have high yield strength or tensile strength, it is necessary to form a high content of retained austenite. This content can for example amount to 20%. Examples of those steels are CBF (carbide free Bainit)- and TBF (TRIP-aided bainitic ferrite) steels. To achieve the required characteristic values in general a heat treatment, which is expensive, complex and technically difficult to realize, is necessary for these steels, to stabilize the desired amount of retained austenite down to room temperature. This heat treatment requires a complex process control and is difficult to be implemented with process reliability in usual production facilities of plants for manufacturing chassis components, in particular for tube manufacturing. The characteristic values of the microstructure which is preferably used according to the invention are mainly caused by the bainite portion. Hence, the amount of retained austenite, which is required in the state of the art, is not necessary and the manufacturing of the chassis component can be simplified and in particular the manufacturing costs can be lowered.

According to a preferred embodiment, the chassis component consists of steel material on iron basis, which comprises the following alloying elements in weight percent:

| | |
|---|---|
| C | 0.06-0.15% |
| Mn | 1.0-3.0% |
| Si | 0.4-2.0% |
| Cr | >0.4% and maximum 2.0%. |

According to the invention carbon C is present up to a maximum of 0.15 wt. %. Thereby, the cementite formation FE₃C in the steel material can be prevented or at least can be kept low. According to the invention, however, also a carbon content of up to a maximum of 0.13% can be sufficient to achieve these properties.

Silicon Si is added in an amount of at least 0.4 wt. %. It is also possible to add silicon in an amount of at least 0.5 wt. %. By this addition on the one hand a sufficient bainite formation can be achieved and on the other hand silicon also serves for suppressing the FE₃C-formation.

Manganese Mn is added in an amount of at least 1.0 wt. %. Also these means guarantee a sufficient bainite formation in the material.

According to the invention, chromium may also be present in smaller amounts than the indicated lower limit of 0.4 wt. %. The lower limit of chromium can thus for example also be indicated as 0 wt. %. According to a preferred embodiment chromium Cr is added, however, in an amount of more than 0.4 wt. %. Thereby a temper resistance of the material and thus of the chassis component can be achieved. In addition, the through-hardenability is improved by the addition of chromium. According to a preferred embodiment, chromium, however, is added up to maximum of 2 wt. %. Thereby the costs for the material of the chassis component are lower.

According to a further embodiment, the steel material in addition comprises at least one of the following alloying elements: vanadium, titanium, boron, nickel, molybdenum, niobium and aluminium. If present, these alloying elements are present in the following amounts in weight percent:

| | |
|---|---|
| V | max. 0.15 |
| Ti | max. 0.1 |
| B | max. 0.005 |
| Ni | max. 2.0 |
| Mo | max. 0.5 |
| Nb | max. 0.1 |
| Al | max. 0.25 |
| N | max. 0.1. |

In addition, unavoidable impurities can be present in the steel material, which is hereinafter also referred to as material.

According to an embodiment, the chassis component is a hot-formed and subsequently air-cooled part. During the hot-forming, in particular hot-rolling, the semi-finished product or the preform of the chassis component is therein heated to a temperature, which is above the Ac3 temperature of the material. In the preferred embodiment, the chassis component is manufactured without subsequent heat treatment after the hot-forming. In particular, it is not necessary to conduct a heat treatment after the hot-rolling of the tubular element or after the assembly of the chassis component. It has shown that, nevertheless, the properties according to the invention of the chassis component can be adjusted.

The present invention also relates to the use of an inventive chassis component in a motor vehicle.

According to a further aspect, the problem is solved by the use of a material for manufacturing a chassis component, in particular for a part of a wheel suspension and/or steering system of the motor vehicle. The material is characterized in that the material is a steel material on iron basis, which comprises the following alloying elements in weight percent:

| | |
|---|---|
| C | 0.06-0.15% |
| Mn | 1.0-3.0% |
| Si | 0.4-2.0% |
| Cr | >0.4% and max. 2.0%. |

The advantages of these alloying elements in the material which is used according to the invention have already been described above.

In addition, it should be noted that the material which is used according to the invention is an inexpensive material due to the mandatorily contained alloying elements, which are comparatively inexpensive. With the material which is used according to the invention, nevertheless, the inventive properties of the chassis component can be adjusted reliably.

According to a further embodiment, the steel material in addition comprises at least one of the following alloying elements: vanadium, titanium, boron, nickel, molybdenum, niobium and aluminium. If present, these alloying elements are preferably present in the following amounts in weight percent:

| | |
|---|---|
| V | max. 0.15 |
| Ti | max. 0.1 |
| B | max. 0.005 |
| Ni | max. 2.0 |
| Mo | max. 0.5 |
| Nb | max. 0.1 |
| Al | max. 0.25 |
| N | max. 0.1. |

According to a preferred embodiment, the aluminum content is at least 0.05 wt. %. With this aluminum content the bainitic transformation can be supported. If the aluminum content is below this content, it may occur that the bainitic transformation takes place to slowly and that thus the preferably yielded bainite content may not be achieved in a simple manner.

According to a preferred embodiment, the content of niobium in the material according to the invention is at least 0.001 wt. %, particularly preferably at least 0.01 wt. %. By this addition of niobium, a good grain refinement in the material can be achieved and the properties according to the invention can thus be achieved reliably.

One example of a composition of the material which is used according to the invention is a material which, besides iron and unavoidable impurities, contains the following alloying elements in the indicated amounts in wt. %:

| | |
|---|---|
| C | 0.08 |
| Mn | 2.28 |
| Si | 0.72 |
| Cr | 1.2 |
| Nb | 0.03 |
| Al | 0.03 |
| N | 0.008. |

With such material, the following characteristic values can be achieved: Rp0.2>=600 MPa, Rm>=900 MPa, A5>16%.

Advantages and features, which are described with respect to the motor vehicle, the chassis component or the material—as far as applicable—also relate to the respective other subject and are thus potentially only described once.

### BRIEF DESCRIPTION OF THE DRAWINGS

In the following, the embodiment of a chassis component is described with reference to the attached FIGURE.

FIG. 1: shows a schematic depiction of the assembly of a chassis component according to the present invention.

### DETAILED DESCRIPTION OF THE PREFERRED EMBODIMENT

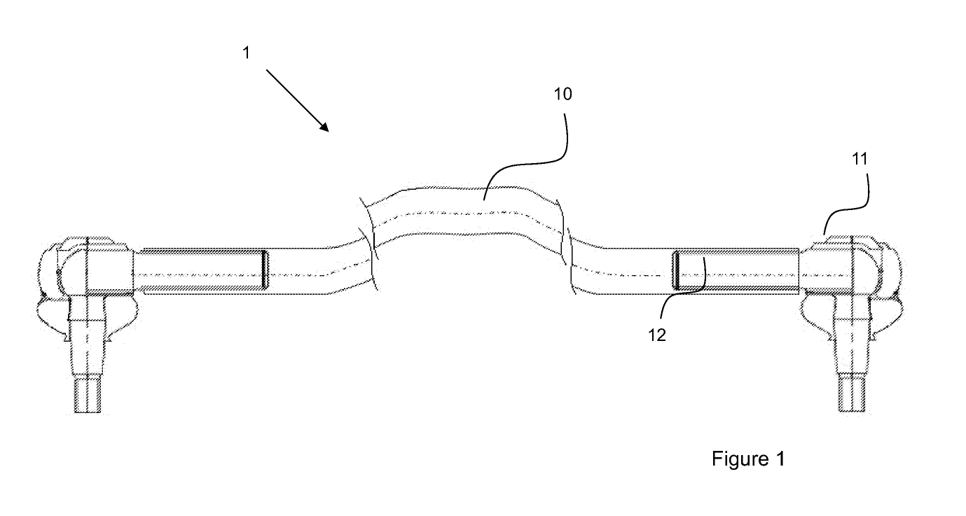

In FIG. 1 an embodiment of a chassis component is schematically shown, which in the depicted embodiment is a tie rod. The tie rod 1 in the depicted embodiment has a tubular element 10. The tubular element 10 preferably is a seamless tubular element 10. At both ends of the tubular element 10 a tie rod end 11 is provided, respectively. The tie rod end 11 is connected to the tubular element 10 by means of a pin 12, which is introduced into the end of the tubular element 10. The pins 12 may for example be pressed with the tubular element 10. The tie rod 1 is exposed to bending load and in addition to tension/compression loads in the middle during use.

One advantage of the invention is thus, that the customer obtains inexpensive parts and in particular tubes with the potential for light weight construction due to the considerably higher tensile strength compared to known products. In addition, due to the air-hardened delivery condition a good suitability for lacquering provided. Due to the preferably formed bainitic structure, in addition, a high durability under dynamic load is achieved.

### MODIFICATIONS OF THE PREFERRED EMBODIMENTS

It should be understood that many additional changes in the details, materials, steps and arrangements of parts, which have been herein described and illustrated in order to explain the nature of the present invention, may be made by those skilled in the art while still remaining within the principles and scope of the invention.

### REFERENCE NUMBERS

1 chassis component (tie rod)
10 tubular element
11 spherical head
12 Pin

1. Motor vehicle with at least one chassis component, characterized in that the chassis component has a yield strength Rp0.2 of at least 600 MPa, a tensile strength Rm of at least 850 MPa and is utilized in a delivery condition air-hardened and in that the chassis component consists of an air-hardening, mainly bainitic material.

2. Chassis component for a motor vehicle, in particular a commercial vehicle, characterized in that the chassis component has a yield strength Rp0.2 of at least 600 MPa, a tensile strength Rm of at least 850 MPa and is utilized in a delivery condition air-hardened and in that the chassis component consists of an air-hardening, mainly bainitic material.

3. Chassis component according to claim 2, characterized in that the chassis component is part of a wheel suspension and/or steering system of the motor vehicle and in particular is a tie rod, a steering rod, a coupling rod, an axle guide or a different tubular part with tension-compression load.

4. Chassis component according to claim 2, characterized in that the chassis component has a structure, which consists of at least 60% bainite, with the remainder comprising at least one from the group consisting of ferrite, martensite and retained martensite.

5. Chassis component according to claim 2, characterized in that the chassis component consists of a steel material on iron basis, which comprises the following alloying elements in weight percent:

| | |
|---|---|
| C | 0.06-0.15% |
| Mn | 1.0-3.0% |
| Si | 0.4-2.0% |
| Cr | >0.4% and max. 2.0%. |

6. Chassis component according to claim 5, characterized in that the steel material comprises at least one of the following alloying elements in weight percent:

| | |
|---|---|
| V | max. 0.15 |
| Ti | max. 0.1 |
| B | max. 0.005 |
| Ni | max. 2.0 |
| Mo | max. 0.5 |
| Nb | max. 0.1 |
| Al | max. 0.25 |
| N | max. 0.1. |

7. Chassis component according to claim 2, characterized in that the chassis component is a hot-formed and subsequently cooled at air part.

8. Use of a chassis component for a motor vehicle, in particular a commercial vehicle, characterized in that the chassis component has a yield strength Rp0.2 of at least 600 MPa, a tensile strength Rm of at least 850 MPa and is utilized in a delivery condition air-hardened and in that the chassis component consists of an air-hardening, mainly bainitic material in a motor vehicle according to claim 1.

9. Use of a material for a chassis component, in particular for a part of a wheel suspension and/or steering system of a motor vehicle, characterized in that the material is a steel material on iron basis, which comprises the following alloying elements in weight percent:

| | |
|---|---|
| C | 0.06-0.15% |
| Mn | 1.0-3.0% |
| Si | 0.4-2.0% |
| Cr | >0.4% and max. 2.0%. |

10. Use according to claim 9, characterized in that the material comprises at least one of the following alloying elements in weight percent:

| | |
|---|---|
| V | max. 0.15 |
| Ti | max. 0.1 |
| B | max. 0.005 |
| Ni | max. 2.0 |
| Mo | max. 0.5 |
| Nb | max. 0.1 |
| Al | max. 0.25 |
| N | max. 0.1. |

11. Use according to claim 10, characterized in that the aluminum content is at least 0.05 wt. %.
